(19) United States
(12) Patent Application Publication
(10) Pub. No.: US 2007/0137946 A1
(43) Pub. Date: Jun. 21, 2007

(54) Method for installing an elevator, and elevator

(76) Inventors: Esko Aulanko, Kerava (FI); Jorma Mustalahti, Hyvinkaa (FI); Johannes De Jong, Jarvenpaa (FI); Pekka Rantanen, Hyvinkaa (FI)

Correspondence Address: HARNESS, DICKEY & PIERCE, P.L.C., P.O. BOX 8910, RESTON, VA, 20195, US

(21) Appl. No.: 11/649,811

(22) Filed: Jan. 5, 2007

Related U.S. Application Data
(63) Continuation of application No. PCT/FI05/00263, filed on Jun. 6, 2005.

(30) Foreign Application Priority Data
Jul. 30, 2004 (FI) 20041043

(51) Int. Cl. B66B 17/12

(52) U.S. Cl. 187/404

(57) ABSTRACT

Elevator without counterweight, in which elevator there is a compensating system separating the roping portion of the hoisting ropes above the elevator car from the roping portion of the hoisting ropes below the elevator car and in which the rope tension is arranged by means of the compensating system to be greater in the portion of roping above the elevator car than in the portion of roping below the elevator car, installed by raising the travel height of the elevator at least once. When raising the travel height, the extension of the hoisting ropes is fed in via the compensating system or via the rope fastening in the compensating system.

This application is a continuation of PCT/FI2005/000263 filed on Jun, 6, 2005, which is an international application claiming priority from FI 20041043 filed Jul. 30, 2004, the entire contents of which are hereby incorporated by reference.

The present invention relates to a method as defined in the preamble of claim 1 and an elevator as defined in the preamble of claim 6.

In high-rise buildings, elevators are often needed during the construction stage before the building has been completed. Elevators are needed e.g. for construction-time use to allow the constructors to reach as high levels in the building as possible by elevator. Similarly, when the lower floors of a building are completed before the upper floors, the elevators must be available for use by the people already using the completed floors. As the construction work is progressing, the elevators have to be able to serve floors as high up as possible.

A prior-art solution for this type of construction-time use is the so-called jump-lift, wherein the hoisting height of the elevator is increased in steps of one or more floor levels each time when the construction work has reached a sufficient height relative to the previous jump. The elevator machine room is removed upwards by the above-mentioned number of floors and all the components dependent on the hoisting height, such as car cables, guide rails, overspeed governor ropes and other components mounted in the shaft, electric equipment in the shaft, shaft cables, compensation ropes etc. are extended to cover the height of the entire completed shaft.

In prior art, the machine room has been lifted by using the building's own construction hoist, among other things. The problem in this case is that the elevator installation is dependent on the use of the construction hoist. The construction hoist may be needed elsewhere on the building site at the same time, in which case the hoist will not be available for use at the desired time or for a time long enough. Likewise, it may be very difficult to get an opportunity to utilize the construction hoist for temporary needs.

Another prior-art solution for the installation of an elevator is disclosed in PCT specification no. WO2004/050526, wherein instead of utilizing the construction hoist, the hoisting machine of the elevator and certain other related components are lifted higher in the elevator shaft one jump at a time as the building progresses and the ropes between the elevator car and the counterweight are extended to cover the increased travel height.

One of the objectives in elevator development work is to achieve efficient and economical utilization of building space. In recent years, this development work has produced various elevator solutions without machine room, among other things. Good examples of elevators without machine room are disclosed in specifications EP 0 631 967 (A1) and EP 0 631 968. The elevators described in these specifications are fairly efficient in respect of space utilization as they have made it possible to eliminate the space required by the elevator machine room in the building without a need to enlarge the elevator shaft. In the elevators disclosed in these specifications, the machine is compact at least in one direction, but in other directions it may have much larger dimensions than a conventional elevator machine.

In these basically good elevator solutions, the space required by the hoisting machine limits the freedom of choice in elevator lay-out solutions. Space is needed for the arrangements required for the passage of the hoisting ropes. It is difficult to reduce the space required by the elevator car itself on its track and likewise the space required by the counterweight, at least at a reasonable cost and without impairing elevator performance and operational quality. In a traction sheave elevator without machine room, mounting the hoisting machine in the elevator shaft is often difficult, especially in a solution with machine above, because the hoisting machine is a sizeable body of considerable weight. Especially in the case of larger loads, speeds and/or hoisting heights, the size and weight of the machine are a problem regarding installation, even to the extent that the required machine size and weight have in practice limited the sphere of application of the concept of elevator without machine room or at least retarded the introduction of said concept in larger elevators. In modernization of elevators, the space available in the elevator shaft often limits the area of application of the concept of elevator without machine room. One prior-art solution is disclosed in publication U.S. Pat. No. 5,788,018, in which the elevator car is suspended with a suspension ratio of 1:1, and in which various tensioning devices are used to tension the continuous rope. The compensation sheave described in this publication is regulated by a separate control system, said system being controlled by means of an external control, which system requires control implemented by means of a complex external control. A recent traction sheave elevator solution with no counterweight, WO2004041704, presents a viable solution in which movement of the elevator car in the elevator is based on traction friction from the hoisting ropes of the elevator by means of a traction sheave. This elevator solution is primarily aimed at low buildings and/or buildings with a low hoisting height. The problems that are solved in this publication are mainly applicable for use in relatively low buildings, and although the concepts also apply to larger hoisting heights, larger hoisting heights and higher speeds introduce new problems to be solved. In prior-art elevator solutions without counterweight, the tensioning of the hoisting rope is implemented by means of a weight or spring, and this is not an attractive approach to implementing the tensioning of the hoisting rope. Another problem with elevator solutions without counterweight, e.g. when long ropes are also used due to e.g. a large hoisting height or high buildings and/or the length of the rope due to large suspension ratios, is compensation of the elongation of the ropes and the fact that, due to rope elongation, the friction between the traction sheave and the hoisting ropes is insufficient for the operation of the elevator.

The object of the present invention is to achieve at least one of the following objectives. The object of the present invention is to overcome the above-mentioned drawbacks and to facilitate and accelerate construction-time elevator installation by providing an economical and reliable method for construction-time installation of an elevator that is easy and simple to implement. On the one hand, it is an aim of the invention to develop the elevator without machine room and/or the elevator without counterweight further so as to allow more effective space utilization in the building and/or elevator shaft than before, and, on the other hand, especially to improve elevator installation and to enable use of the elevator in a building in the construction stage. This means that the elevator should be capable of being installed in a fairly narrow elevator shaft if necessary. One objective is to achieve an elevator in which the hoisting rope has a good grip/contact on the traction sheave. A further aim of the invention is to achieve an elevator solution without counterweight without compromising the properties of the elevator. An additional objective is to eliminate the effects of rope elongation. Yet a further objective of the invention is to achieve an elevator by means of which it is possible to implement an elevator without counterweight in high-rise buildings and/or a fast elevator without counterweight. Another objective is to achieve an apparatus for enabling construction-time installation of an elevator. The object of the invention is especially to apply an elevator without counterweight during construction-time use and/or to enable increasing the height of an elevator without counterweight as the building progresses and/or to achieve an elevator without counterweight, which can be used during construction as the height of the building increases and can also be used as an elevator when the building is completed. The object of the invention should be achieved without compromising the possibility of varying the basic elevator lay-out.

The method of the invention for installing an elevator during construction time is characterized by what is disclosed in the characterization part of claim 1 and the elevator of the invention is characterized by what is disclosed in the characterization part of claim 6. Other embodiments of the invention are characterized by what is disclosed in the other claims. Some inventive embodiments are also discussed in the descriptive section of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The various embodiments of the invention and the features and details of the embodiment examples can be used in conjunction with each other.

By applying the invention, one or more of the following advantages, among others, can be achieved:
installation of the elevator can be started at a very early stage of construction
the elevator machine room and all its equipment are lifted using a separate lifting arrangement developed for the elevator or by other means when
   the construction hoist is not needed and thus other construction work is not disturbed or retarded
   elevator installation is independent of the use of the building crane
   the machine room need not be supported on the walls of the elevator shaft or on the intermediate floor slabs
   all or at least part of the weight of the machine room, elevator car and counterweight can be advantageously borne by the elevator guide rails during elevator installation, in which case elevator installation produces no extra loads on the walls and intermediate floor slabs
   no extra openings and reinforcements for elevator installation need to be made in the concrete structures of the building
   the invention enables a transportation capacity and logistics utilization at least four times better than in prior-art construction-time elevators
allows savings in time by constructors and sub-contractors and leads to faster completion of the building project
elevator installation times are shortened and the total installation costs reduced
safer installation environment
finished floors are ready for normal elevator operation very soon after their completion
less space is needed outside the building
easy to establish as a standard installation method.

In the following, the invention will be described in more detail by the aid of a few examples of its embodiments with reference to the attached drawings, wherein

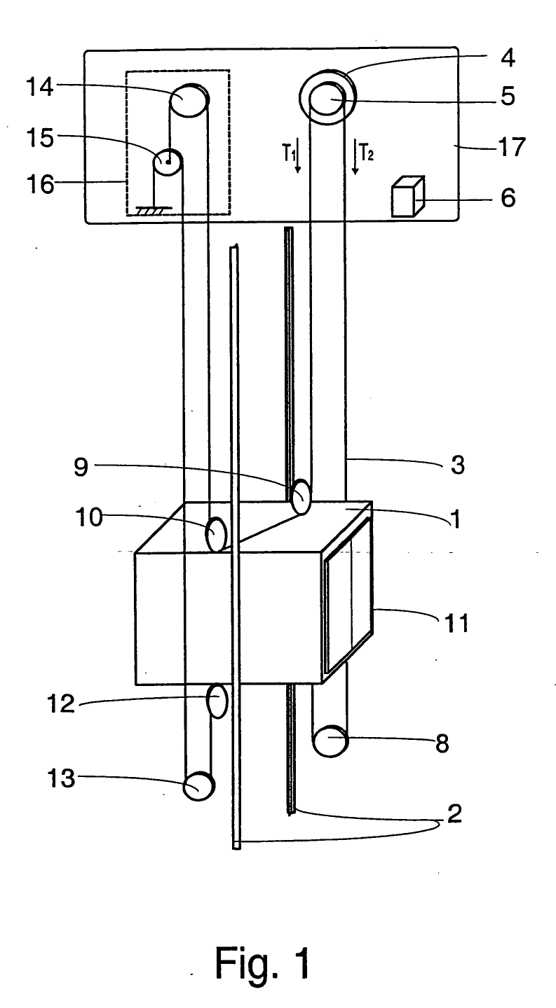

FIG. 1 presents a diagrammatic view of a traction sheave elevator without counterweight according to the invention,

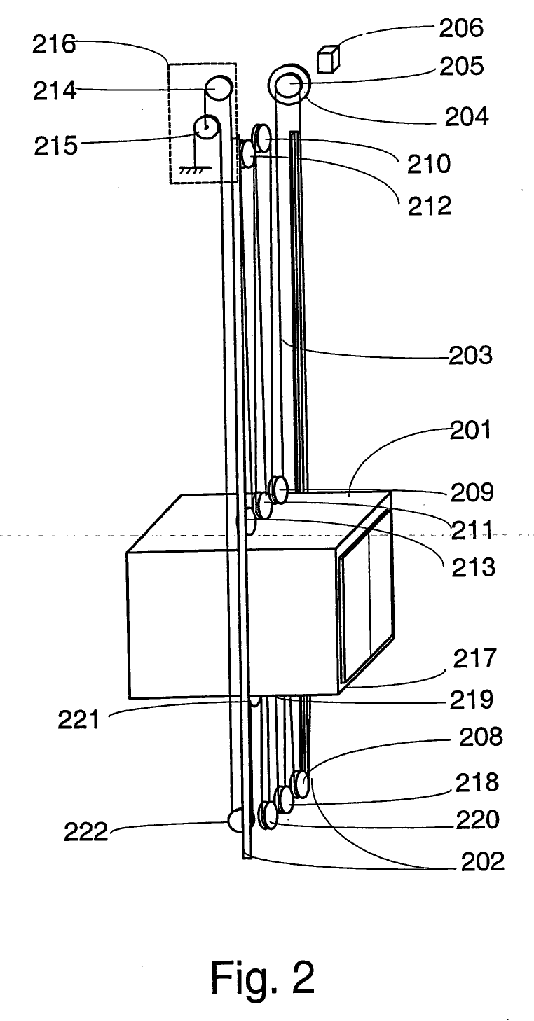

FIG. 2 presents a diagrammatic view of another traction sheave elevator without counterweight according to the invention,

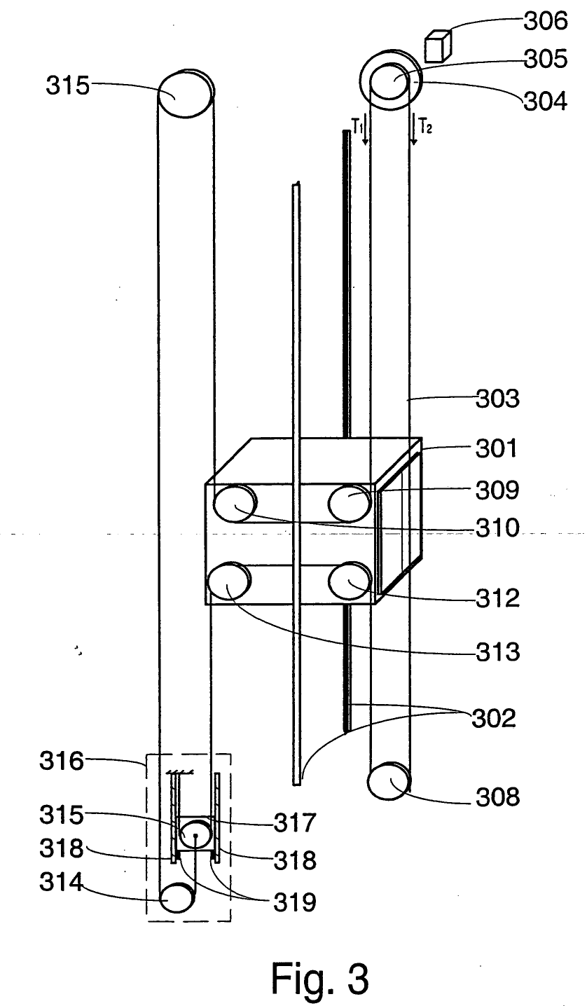

FIG. 3 presents a diagrammatic view of a third traction sheave elevator without counterweight according to the invention and a compensating system according to the invention,

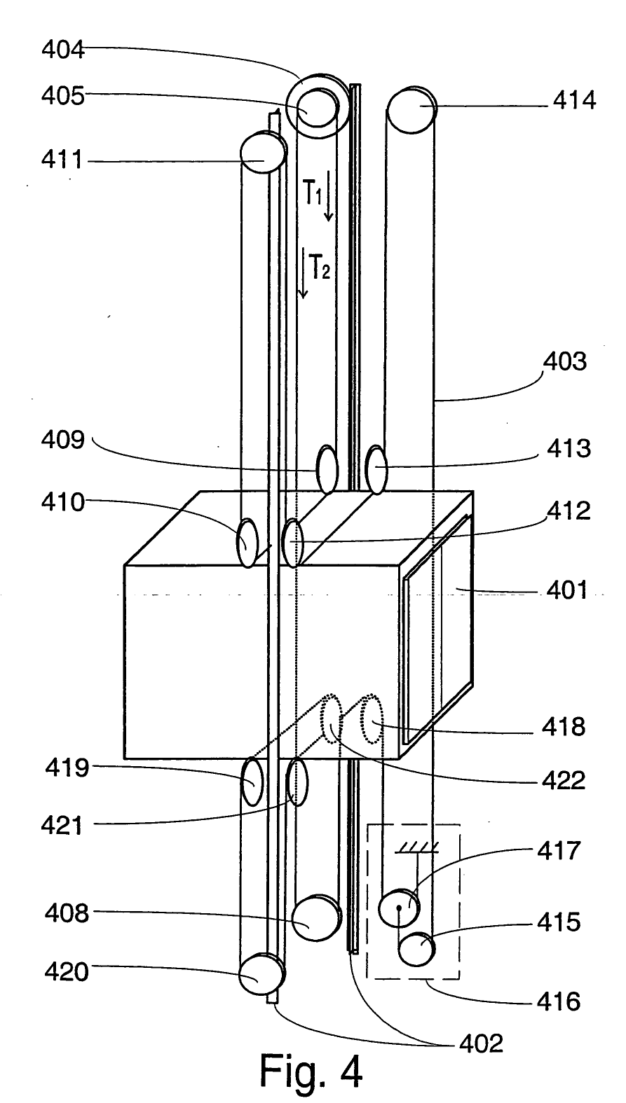

FIG. 4 presents a diagrammatic view of a fourth traction sheave elevator without counterweight according to the invention,

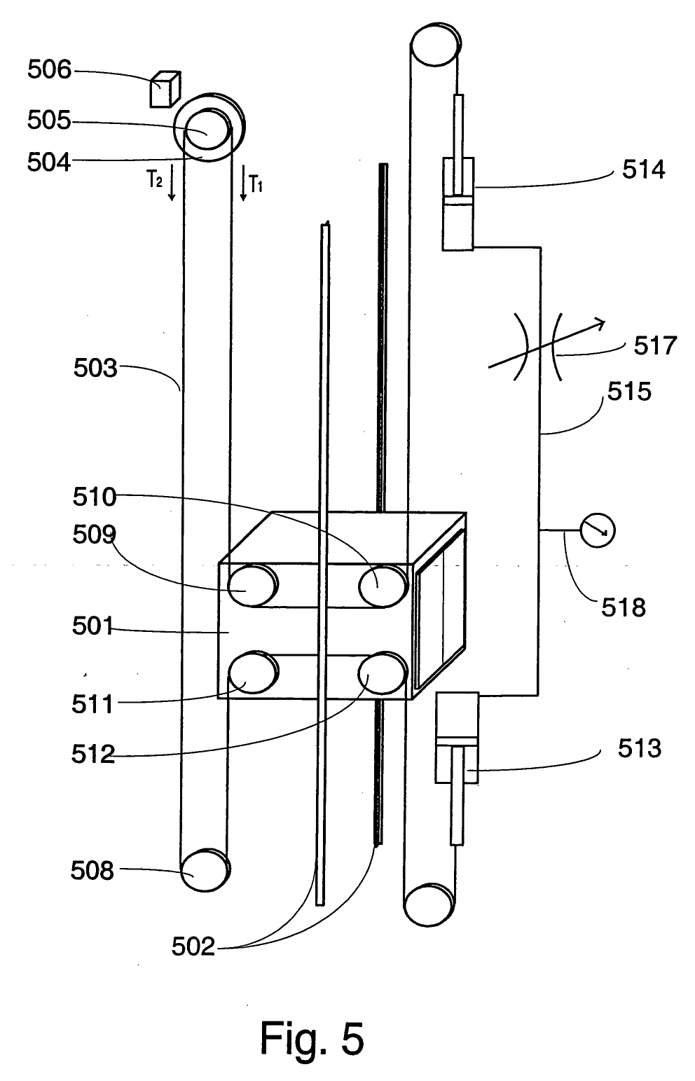

FIG. 5 presents a diagrammatic view of another traction sheave elevator without counterweight and with a compensating system according to the invention,

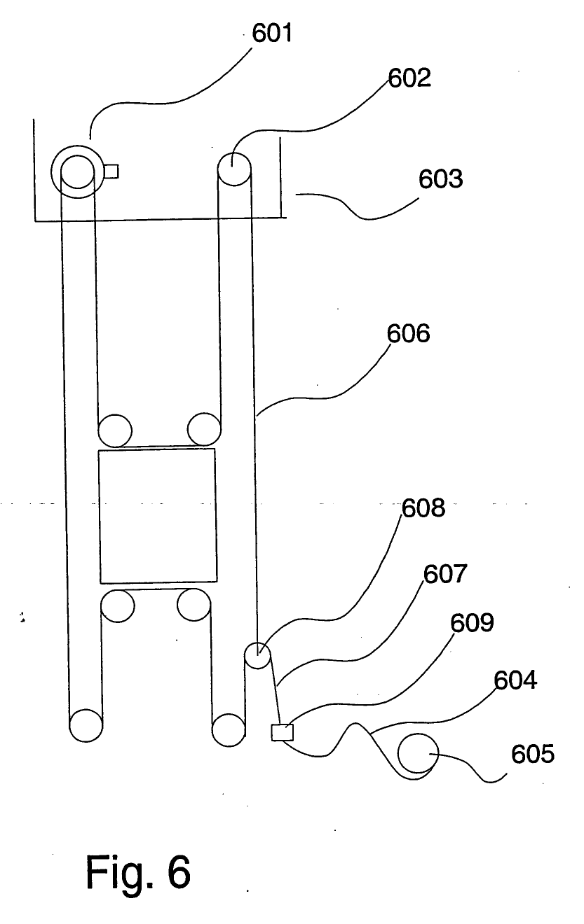

FIG. 6 presents a diagrammatic view of an arrangement that enables an increase in the height of the elevator,

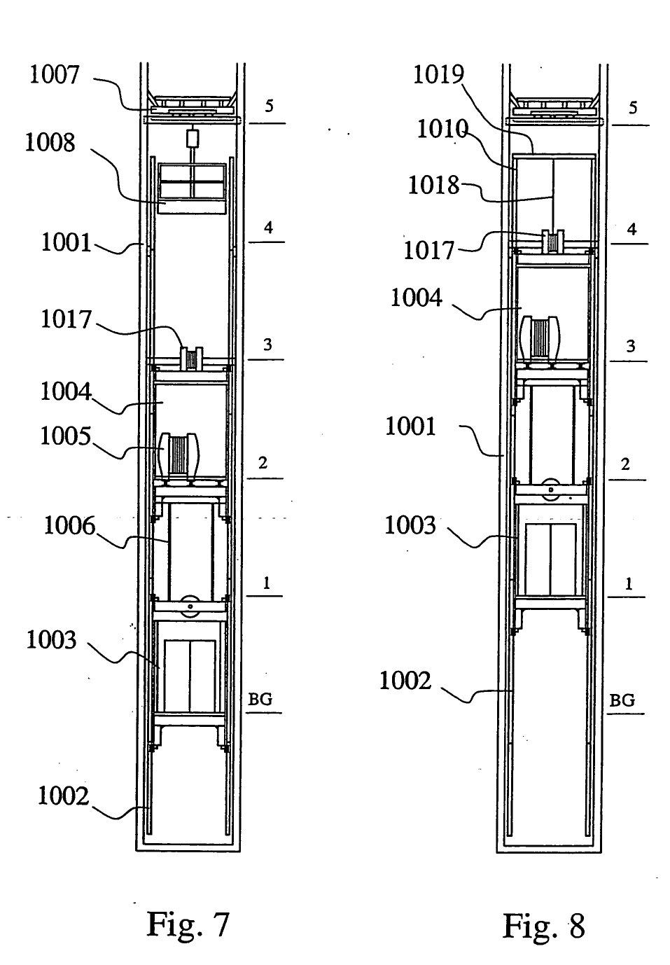

FIG. 7 presents a diagrammatic front view of an elevator installation situation according to the invention, in which the elevator car has already been installed on the foundation floor,

FIG. 8 presents a diagrammatic front view of an elevator installation situation according to the invention, in which the elevator car has been lifted to the first floor,

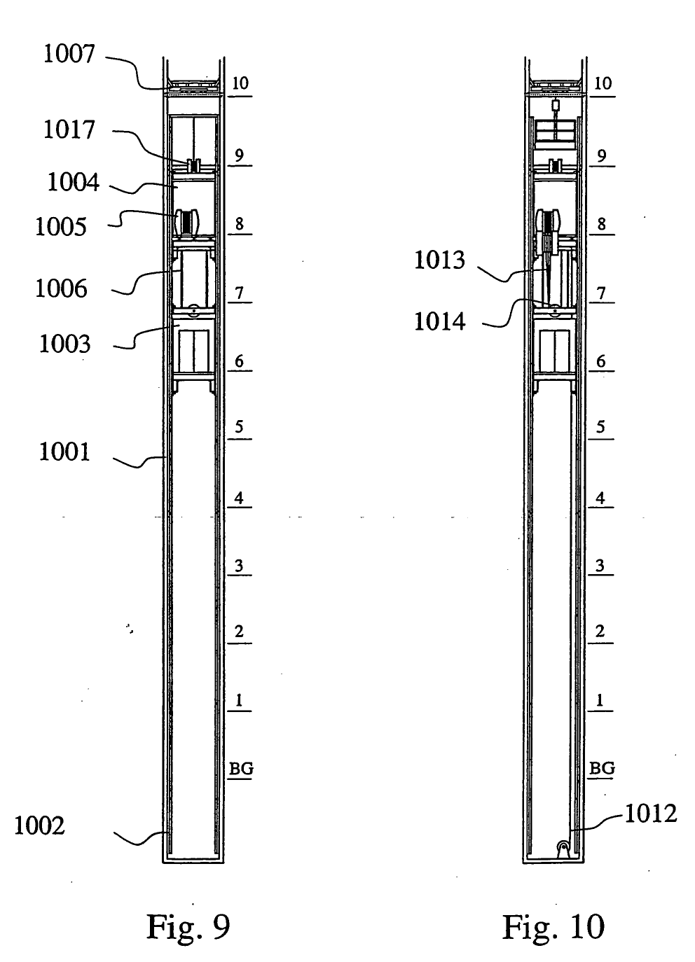

FIG. 9 presents a diagrammatic front view of an elevator installation situation according to the invention, in which a jump lift has been carried out and the elevator car has been lifted to the sixth floor, and

FIG. 10 presents a diagrammatic front view of an elevator installation situation according to the invention, in which a jump lift has been carried out and the hoisting ropes of the elevator as well as the rope of the overspeed governor have been installed to this height.

FIG. 1 presents a diagrammatic illustration of a traction sheave elevator without counterweight according to the invention, in which the compensating system according to the invention is situated in the upper part of the shaft, i.e. in the case of FIG. 1 in the machine room 17. The elevator is an elevator with machine room, with a drive machine 4 placed in the machine room 17. The elevator shown in the figure is a traction sheave elevator without counterweight, in which the elevator car 1 moves along guide rails 2. In elevators with a large hoisting height, the elongation of the hoisting rope involves a need to compensate the rope elongation, which has to be done reliably within certain permitted limit values. In that case it is essential in respect of elevator operation and safety that the rope portion below the elevator car should be kept sufficiently tight. In the rope force compensating system 16 of the invention presented in FIG. 1, very long movement for compensating rope elongation is achieved. This enables compensation of also large elongations, which is not often possible with simple lever solutions or with spring solutions. The compensating system 16 of the invention shown in FIG. 1 keeps the rope tensions T₁ and T₂ acting over the traction sheave at a constant ratio of T₁/T₂. In the case presented in FIG. 1 the T₁/T₂ ratio is 2/1. With even suspension ratios above and below the elevator car, the compensating system 16 is disposed in the machine room or elevator shaft or other place suitable for the purpose that is not connected to the elevator car, and with odd suspension ratios above and below the elevator car the compensating system 16 is connected to the elevator car.

In FIG. 1 the passage of the hoisting ropes is as follows: One end of the hoisting ropes 3 is fixed to the diverting pulley 15 and/or any suspension arrangement for said diverting pulley. Diverting pulleys 14 and 15 form the compensating system 16 in FIG. 1. The compensating system 16 is disposed in the machine room 17 of the elevator. From diverting pulley 15 the hoisting ropes 3 run upwards encountering the other diverting pulley 14 of the compensating system 16, which the rope passes around via the rope grooves in the diverting pulley 14. These rope grooves can be coated or uncoated, e.g. with friction increasing material, such as polyurethane or other appropriate material. All the diverting pulleys of the elevator or only some and/or the traction sheave can be coated with said material. After passing around the diverting pulley 14, the ropes continue downwards in the elevator shaft to the diverting pulley 10 mounted on the elevator car 1, and having passed around this pulley the ropes 3 run across the top of the elevator car 1 to diverting pulley 9, which is mounted on the elevator car 1 and to the other side of the elevator shaft. The passage of the hoisting ropes 3 to the other side of the elevator shaft is arranged by means of diverting pulleys 10 and 9, a preferred way of arranging the passage of the hoisting rope across the top of the elevator car 1 being diagonally via the centre of mass of the elevator car. After passing around diverting pulley 9 the rope returns upwards to the hoisting machine 4 located in the machine room 17 and to the traction sheave 5 of said machine. The diverting pulleys 14,10,9 together with the traction sheave 5 of the hoisting machine 4 form the suspension arrangement above the elevator car, the suspension ratio of which is the same as that of the suspension arrangement below the elevator car, said suspension ratio being 2:1 in FIG. 1. The first rope tension T₁ acts on the part of the hoisting rope above the elevator car. After passing around the traction sheave 5 the ropes continue their passage along the elevator shaft to the diverting pulley 8, said diverting pulley 8 being advantageously disposed in the lower part of the elevator shaft. After passing around the diverting pulley 8 the ropes 3 continue upwards to the diverting pulley 11 mounted on the elevator car, said diverting pulley not being visible in FIG. 1. After passing around the diverting pulley 11 the hoisting ropes continue their passage, in a similar manner as the roping above the elevator car 1, across the elevator car 1 to the diverting pulley 12 positioned on the other side of the elevator car and at the same time the hoisting ropes move to the other side of the elevator shaft. After passing around the diverting pulley 12, the hoisting ropes 3 continue downwards to the diverting pulley 13 in the lower part of the elevator shaft, and having passed around this pulley continue and return to the other diverting pulley 15 of the compensatingsystem 16 in the machine room 17 of the elevator, and having passed around said diverting pulley 15 the hoisting ropes run to the fixing point of the other end of the hoisting rope, said fixing point being located in a suitable place in the machine room 17 or in the elevator shaft. The diverting pulleys 8,11,12,13 form the suspension arrangement of the hoisting ropes below the elevator car and a part of the roping. The other rope tension T₂ of the hoisting rope acts on this part of the hoisting ropes below the elevator car. The diverting pulleys of the lower part of the elevator shaft can be immovably fixed to the frame structure formed by the guide rails 2 or to a beam structure located at the bottom end of the elevator shaft or each one separately to the lower part of the elevator shaft or to any other fixing arrangement suited to the purpose. The diverting pulleys on the elevator car can be immovably fixed to the frame structure of the elevator car 1, such as e.g. to the car sling, or to a beam structure or beam structures on the elevator car or each one separately to the elevator car or to any other fixing arrangement suited to the purpose. The diverting pulleys can also be modular in structure, e.g. in such a way that they are separate modular structures, such as e.g. of the cassette type, that are immovably fixed to the shaft structures of the elevator, to the structures of the elevator car and/or car sling or to another appropriate place in the elevator shaft, or in its proximity, or in connection with the elevator car and/or in the machine room of the elevator. The diverting pulleys located in the elevator shaft and the devices of the hoisting machine and/or the diverting pulleys connected to the elevator car can be disposed either all on one side of the elevator car in a space between the elevator car and the elevator shaft or otherwise they can be disposed on different sides of the elevator car in the manner desired.

The drive machine 4 placed in the machine room 17 is preferably of a flat construction, in other words the machine has a small thickness dimension as compared to its width and/or height. In the elevator without counterweight of the invention, it is possible to use a drive machine 4 of almost any type and design that fits into the space intended for it. For example, it is possible to use a geared or gearless machine. The machine may be of a compact and/or flat size. In the suspension solutions according to the invention, the rope speed is often high compared to the speed of the elevator, so it is possible to use even unsophisticated machine types as the basic machine solution. The machine room of the elevator is advantageously provided with equipment required for the supply of power to the motor driving traction sheave 5 as well as equipment needed for elevator control, both of which can be placed in a common instrument panel 6 or mounted separately from each other or integrated partly or wholly with the drive machine 4. A preferred solution is a gearless machine comprising a permanent magnet motor. FIG. 1 illustrates a preferred suspension solution in which the suspension ratio of the diverting pulleys above the elevator and the diverting pulleys below the elevator car is the same 2:1 suspension in both cases. To visualize this ratio in practice, it means the ratio of the distance traveled by the hoisting rope to the distance traveled by the elevator car. The suspension above the elevator car 1 is implemented by means of the diverting pulleys 14,10,9 and the traction sheave 5 and the suspension arrangement below the elevator car 1 is implemented by means of the diverting pulleys 13,12,11,8. Other suspension arrangements can also be used to implement the invention, such as e.g. larger suspension ratios, which are implemented by means of a number of diverting pulleys above and below the elevator car. The elevator of the invention can also be implemented as a solution without machine room or the machine may be mounted to be movable together with the elevator. It is advantageous to place the compensating system 16 in the upper part of the elevator, preferably in the machine room, especially in elevators with a high travel height, which elevators are usually also fast in terms of travel speed. In that case, the placement of the compensating system according to the invention results in a considerable reduction in the overall rope elongation of the hoisting ropes of the elevator, because with this placement of the compensating system the upper portion of the hoisting ropes, i.e. the portion located above the compensating system, in which there is greater rope tension, becomes shorter. The portion of the hoisting ropes below the compensating system, however, then increases. Placing the compensating system in the machine room also enables easier access to it.

The compensating system 16 for rope force in the elevator that is presented in FIG. 1 compensates rope elongations by means of the movement of the diverting pulley 15. Diverting pulley 15 moves a limited distance thereby equalizing elongations of the hoisting ropes 3. Additionally, the arrangement in question keeps the rope tension over the traction sheave 5 constant, whereby the ratio between the first and second rope tension, the T₁/T₂ ratio, in the case of FIG. 1 is approximately 2/1. Diverting pulley 15, which in FIG. 1 functions as a compensating pulley, can be controlled by means of guide rails to stay on its desired track, especially in situations in which the compensating system 16 receives a powerful impact, such as e.g. during wedge gripping of the elevator. By means of the guides of diverting pulley 15, the distance between the elevator car and the compensating system can be kept to that desired and movement of the compensating system can be kept under control. The guide rails used for the compensating system can be almost any type of guide rails suited to the purpose, such as e.g. guide rails made of metal or other material suitable for the purpose or e.g. rope guides. A buffer can also be fitted to the compensating system 16 to dampen the impacts of the diverting pulleys of the compensating system and/or to prevent slackening of the compensating system. The buffer used can be disposed e.g. in such a way that the compensating pulley 15 remains supported by the buffer before the rope elongation of the hoisting ropes has had time to fully unlay into the hoisting ropes, especially into the part of the ropes above the elevator car. One design criterion in the elevator of the invention has been to ensure that the compensating system is prevented from feeding rope from the compensating system in the direction of the portions of rope below the elevator car when ranging outside the normal compensation area of the compensating system, thereby maintaining a certain tension in the hoisting ropes. It is also possible to implement the compensating system 16 differently than presented in the forgoing example, such as with more complex suspension arrangements in the compensating system, such as e.g. by arranging different suspension ratios between the diverting pulleys of the compensating system. It is also possible to use a lever suited to the purpose, compensating pulleys or other rope tension compensating arrangement suited to the purpose as the compensating system 16. A preferred embodiment of the elevator with a 2:1 suspension ratio presented in FIG. 1 is an elevator with a speed of approximately 6 m/s in which the mass of the car and maximum load is about 4000 kg, and in which elevator only six hoisting ropes each of about 13 mm in diameter are needed. The preferred areas of application for the elevator of the invention with a suspension ratio of 2:1 are elevators whose speed is in a range above 4 m/s.

FIG. 2 presents a diagrammatic illustration of the structure of an elevator according to the invention. The elevator presented in FIG. 2 resembles the elevator in FIG. 1 with the difference that the compensating system 216 of the elevator without counterweight, the hoisting machine 204 and the equipment required for the supply of power to the motor as well as equipment needed for elevator control 206 are advantageously disposed in the elevator shaft. The elevator shown in FIG. 2 is an elevator without machine room and the elevator presented in the figure is a traction sheave elevator with machine above and without counterweight, with an elevator car 201 moving along guide rails 202, as in FIG. 1. The passage of the hoisting ropes 203 in FIG. 2 is similar to that in FIG. 1. The difference to the elevator shown in FIG. 1 is how many times the hoisting ropes 203 pass between the elevator car 201 and the diverting pulleys above the elevator car as well as between the elevator car and the diverting pulleys below the elevator car. FIG. 2 presents an elevator with a suspension ratio of 6:1, in which the suspension ratio above the elevator car has been increased to a ratio of 6:1 by means of the diverting pulleys 214,213,212,211,210,209 and the traction sheave 205. The suspension ratio below the elevator car is the same as above it, i.e. also 6:1. This is achieved by means of diverting pulleys 208,217,218,219,220,221,222. The compensating system 216 shown in FIG. 2 is similar to that in FIG. 1, the operation of said compensating system 216 being similar to that presented in FIG. 1. A different type of compensating system to that now presented in the example can also be used in the elevator of FIG. 2. A preferred embodiment of the elevator without counterweight with a 6:1 suspension ratio presented in FIG. 2 is an elevator with a speed of 1.8 m/s and a movable mass, which consists of the mass of the car and its equipment as well as the mass of the maximum load, of about 2000 kg, and in which elevator only five hoisting ropes each of about 8 mm in diameter are needed. The preferred areas of application for the elevator of the invention with a suspension ratio of 6:1 are elevators whose speed is in a range above 1 m/s.

FIG. 3 presents a diagrammatic illustration of the structure of an elevator according to the invention. The elevator is preferably an elevator without machine room, in which the drive machine 304 and the compensating system 316 are disposed in the elevator shaft. In the figure, the compensating system 316 is located in the lower part of the elevator shaft, but can just as well be situated in the upper part of the elevator shaft or in the machine room. The elevator shown in the figure is a traction sheave elevator without counterweight and with machine above, in which the elevator car 301 moves along guide rails 302. The passage of the hoisting ropes in FIG. 3 is similar to that presented in FIG. 1, but in the example presented in FIG. 3 the hoisting ropes of the elevator are advantageously arranged to pass on one side of the elevator car by means of the diverting pulleys 308,309,310,312,313,315 and the compensating system 316 and its diverting pulleys 315,314 and the traction sheave 305 of the hoisting machine 304. The elevator presented in FIG. 3 is an elevator suspended with a suspension ratio of 2:1, wherein the suspension ratio above and below the elevator car 1 the same 2:1 in both cases. FIG. 3 presents the compensating system 316 of the elevator of the invention, said compensating system containing a locking arrangement according to the invention. In FIG. 3, the moving diverting pulley 315 of the compensating system is preferably arranged to travel on its track along the guides 318, and the diverting pulley 315 is preferably suspended on the frame 317, by means of which it moves along the guides 318. A locking means 319, preferably gripping brake elements, is fitted to the frame 317 of the diverting pulley 315, said braking elements preferably gripping the guides 318 or other similar place for stopping and/or retarding movement of the compensating system. In situations where the elevator safety gear grips or the elevator runs onto the buffer or other similar situations, the ratio between the speed of the hoisting rope and the speed of the elevator car changes suddenly or tries to change suddenly. In such cases a sudden strong force is exerted on the compensating system, which causes a sudden movement of the compensating pulleys of the compensating system or the like, which may result in loosening or damage of the hoisting ropes or part of them. Another result may be damage to the compensating pulleys, or similar, of the compensating system or damage to their track. This problem is especially prominent in elevators with high speeds and/or large travel heights. The problem is solved according to the invention by arranging locking 319 for the diverting pulley 315 of the compensating system, or similar, or for its frame 317, said locking preferably gripping the diverting pulley 315 or a similar track or the like, preferably guide 318, in a situation where the speed of movement or the acceleration of the compensating system exceeds a pre-set limit value.

FIG. 4 presents a diagrammatic illustration of an elevator according to the invention. The elevator is preferably an elevator without machine room, in which the drive machine 404 and compensating system are disposed in the elevator shaft. The elevator shown in the figure is a traction sheave elevator without counterweight and with machine above, in which the elevator car 401 moves along guide rails 402. The compensating system 416 is disposed in the lower part of the elevator shaft. The compensating system 416 in FIG. 2 is gravity-assisted and it is possible to add additional weights to it if necessary to improve the operation of the compensation system. An additional force on the compensating system 416 has been arranged, said additional force acting substantially in the same direction as the first rope tension (T₁). By means of the additional force, the second rope tension T₂ is increased in relation to the first rope tension T₁.

In FIG. 4 the passage of the hoisting ropes is as follows: One end of the hoisting ropes 403 is fixed to the diverting pulley 417 and/or any suspension arrangement for it, said diverting pulley 417 being fitted to rest on the rope portion coming downwards from the diverting pulley 418, which hoisting rope portion passes around diverting pulley 417 and runs further to the fixing point of the other end of the hoisting ropes 403 in the elevator shaft. The compensating system 416 is fitted in place in the elevator shaft. From diverting pulley 415 the hoisting ropes 403 run upwards encountering the diverting pulley 414, which is fitted in place in the upper part of the elevator shaft, and around which the rope passes via the rope grooves in the diverting pulley 414. After passing around the diverting pulley 414, the ropes continue downwards to the diverting pulley 413 mounted on the elevator car 401, and having passed around this pulley the ropes 403 run across the elevator car 401 to diverting pulley 412, which is mounted on the elevator car 401 and to the other side of the elevator shaft. The passage of the hoisting ropes 403 to the other side of the elevator shaft is arranged by means of diverting pulleys 413 and 412. After passing around diverting pulley 412 the rope returns upwards to the diverting pulley 411 fitted in place in the upper part of the elevator shaft, and after passing around this pulley returns to the diverting pulley 410 mounted on the elevator car, after passing around which it continues across the elevator car to the diverting pulley 409 mounted on the elevator car, and at the same time to the other side of the elevator shaft. Having passed around the diverting pulley 409 the hoisting ropes run further to the hoisting machine 404 fitted in place in the upper part of the elevator shaft and to its traction sheave 405. The diverting pulleys 414,413,412,411,410,409 together with the traction sheave 405 of the hoisting machine 404 form the suspension arrangement above the elevator car, the suspension ratio of which is the same as that of the suspension arrangement below the elevator car, said suspension ratio being 4:1 in FIG. 4. The first rope tension T₁ acts on the part of the hoisting ropes above the elevator car. After passing around the traction sheave 405 the hoisting ropes go further to the diverting pulley 408 fitted in place in the lower part of the elevator shaft. After passing around diverting pulley 408 the ropes 403 continue upwards to the diverting pulley 422 mounted on the elevator car. After passing around the diverting pulley 422 the hoisting ropes continue their passage, in a similar manner as the roping above the elevator car 401, under the elevator car 401 to the diverting pulley 419 positioned on the other side of the elevator car and at the same time the hoisting ropes 403 move to the other side of the elevator shaft. After passing around the diverting pulley 419 the hoisting ropes 403 continue downwards to the diverting pulley 420 in the lower part of the elevator shaft, and having passed around it continue back to the elevator car 401 and to the diverting pulley 421 fixed to the elevator car, and after passing around this pulley the hoisting ropes continue below the elevator car to the diverting pulley 418 positioned on the other side of the elevator car and at the same time the hoisting ropes 403 move transfer to the other side of the elevator shaft. Having passed around diverting pulley 418 the hoisting rope runs further to the other diverting pulley 417 of the compensating system 416, and after passing around the diverting pulley 417 the hoisting ropes continue to the fixing point for the other end of the hoisting ropes, which is in a suitable place in the elevator shaft. The diverting pulleys 408,422,419,420,421,418,417 form the suspension arrangement of the hoisting ropes below the elevator car and a part of the roping. The other rope tension T₂ of the hoisting rope acts on this part of the hoisting ropes below the elevator car. The diverting pulleys of the lower part of the elevator shaft can be immovably fixed to the frame structure formed by the guide rails 402 or to a beam structure located at the lower end of the elevator shaft or each one separately to the lower part of the elevator shaft or to any other fixing arrangement suited to the purpose. The diverting pulleys on the elevator car can be immovably fixed to the frame structure of the elevator car 401, such as e.g. to the car sling, or to a beam structure or beam structures on the elevator car or each one separately to the elevator car or to any other fixing arrangement suited to the purpose. The diverting pulleys can also be modular in structure, e.g. in such a way that they are separate modular structures, such as e.g. of the cassette type, that are immovably fixed to the shaft structures of the elevator, to the structures of the elevator car and/or car sling or to another appropriate place in the elevator shaft, or in its proximity, or in connection with the elevator car and/or in the machine room of the elevator. The diverting pulleys located in the elevator shaft and the devices of the hoisting machine and/or the diverting pulleys connected to the elevator car can be disposed either all on one side of the elevator car in a space between the elevator car and the elevator shaft or otherwise they can be disposed on different sides of the elevator car in the manner desired.

In the example presented in FIG. 5 the elevator roping and diverting pulleys as well as the hoisting machine and its equipment are disposed on the sides of the elevator car symmetrically, thus there is no diverting pulley or hoisting machine directly above and/or below the path of travel of the elevator car. This allows e.g. a smaller safety clearance above and/or below the elevator car. In addition, the components of the elevator, such as the diverting pulleys and the hoisting machine and the passage of the hoisting rope, are positioned symmetrically on the different sides of the elevator shaft. A preferred embodiment of the elevator with a 4:1 suspension ratio presented in FIG. 5 is an elevator with a speed of approximately 4 m/s and a movable mass, which consists of the mass of the car and its equipment as well as the mass of the maximum load, of about 4000 kg, and in which elevator only eight hoisting ropes each of about 8 mm in diameter are needed. The preferred areas of application for the elevator of the invention with a suspension ratio of 4:1 are elevators whose speed is in the range 1.6 m/s-4.0 m/s.

When the elevator car is suspended with a small suspension ratio, such as e.g. 1:1, 2:1, 3:1 or 4:1, diverting pulleys of a large diameter and hoisting ropes of a large thickness can be used. Below the elevator car it is possible to use smaller diverting pulleys if necessary, because the tension in the hoisting ropes is smaller than in the portion above the elevator car, allowing smaller hoisting rope deflection radiuses to be used. In elevators with a small space below the elevator car, it is advantageous to use diverting pulleys of a small diameter in the rope portion below the elevator car, because by using a rope force compensating system according to the invention the tension of the rope portion below the elevator car can be maintained at a constant level that is lower by the ratio T₁/T₂ than the tension in the rope portion above the elevator car. This makes it possible to reduce the diameters of the diverting pulleys in the rope portion below the elevator car without causing any substantial loss regarding the useful life of the hoisting ropes. For example, the ratio of the diameter D of the diverting pulley to the diameter d of the rope used may be D/d<40, and preferably the D/d ratio may be only D/d=25 . . . 30 when the ratio of the diameter of the diverting pulleys in the rope portion above the elevator car to the diameter of the hoisting ropes is D/d=40. By using diverting pulleys of a smaller diameter, the space required below the elevator car can be reduced to a very small size, which may preferably be only 200 mm.

A preferred embodiment of the elevator of the invention is an elevator without machine room and with machine above, in which the drive machine has a coated traction sheave, and which elevator has thin hoisting ropes of a substantially round cross-section. In the elevator, the contact angle between the hoisting ropes and the traction sheave is greater than 180°. The elevator comprises a unit with a mounting base on which are fitted a drive machine, a traction sheave and a diverting pulley fitted at a correct angle relative to the traction sheave. The unit is secured to the elevator guide rails. The elevator is implemented without counterweight with a suspension ratio of 9:1 so that both the roping suspension ratio above the elevator car and the roping suspension ratio below the elevator car is 9:1, and that the roping of the elevator runs in the space between one of the walls of the elevator car and the wall of the elevator shaft. The solution for compensating the rope elongations of the hoisting rope comprises a set of compensating sheaves, which creates a constant ratio of 2:1 for the ratio T₁/T₂ With the compensating sheave system used, the required compensating distance equals half the magnitude of the rope elongation.

Another preferred embodiment of the elevator of the invention is an elevator without counterweight with a suspension ratio of 10:1 above and below the elevator car. This embodiment is implemented using conventional hoisting ropes preferably of a diameter of 8 mm and a traction sheave made of cast iron at least in the area of the rope grooves. The traction sheave has undercut rope grooves and its angle of contact to the traction sheave has been fitted by means of a diverting pulley to be 180° or greater. When conventional 8 mm ropes are used, the traction sheave diameter is preferably 340 mm. The diverting pulleys used are large rope sheaves which, in the case of conventional 8 mm hoisting ropes, have a diameter of 320,330,340 mm or even more. The rope forces are kept constant so that the ratio T₁/T₂ between them is 3/2.

FIG. 6 presents a diagrammatic illustration of an arrangement that makes it possible to increase the height of an elevator. The arrangement includes a hoisting machine 601 and upper diverting pulleys, in this diagrammatic illustration the upper diverting pulley 602 being in the console 603, which console may be purely a construction-time structure or later form the actual machine room of the elevator or other machine placement site or mounting base, or at least the parts of which console are used in the structure of the actual machine room of the elevator or other machine placement site or mounting base. When the building and also the elevator shaft grow higher while the construction work progresses, arranging elevator traffic in the early stage produces a need to increase the travel height of the elevator. Thus as the construction work progresses, in other words as the travel height of the elevator increases, the console 603 is lifted higher in the elevator shaft. As the elevator is raised, the hoisting rope 604 is fed in from reels 605 or coils to the hoisting ropes 606 that become longer as a result of the increasing travel height. Rope is fed in via the compensating system 607 or the rope fastening 608 in the compensating system. In practice this is done by opening the rope fastening 608 in the compensating system or the fastening 609 of the end of the ropes passing via the compensating system, giving to the roping the amount of extra length rope required by the increase in travel height and securing the rope fastening 608 or 609 again. The preferred method is to feed new rope to the roping via the compensating system, in which case securing the roping is independent of the movement of the compensating system.

According to the method of the invention, the main steps of the elevator installation process are as follows. After the constructor has first mounted in the shaft 1001 a movable and waterproof supporting platform 1007, which is secured to the floor slab of e.g. the fifth floor, the actual elevator installation work is started. First, a working platform 1008 and an auxiliary hoist for the hoisting of elevator components are secured to the supporting platform 1007. Furthermore, the working platform 1008 is provided with slide shoes by means of which the working platform is guided by the elevator guide rails. After this, in the actual first stage of installation, the elevator guide rails 1002 are secured to the lower part of the shaft 1001. During this stage, five guide bars are mounted one above the other, of which the bottommost and the topmost guide bars 1010 are shorter than the other three bars, which are of equal length. With normal floor height, the guide rails now extend nearly to the height of the fifth floor.

In a second stage of the installation process, the landing doors as well as the lighting and electrification of the shaft are installed up to a level as high as possible at this stage. In the example, the equipment is installed up to the level of the fifth floor.

In a third stage of installation, a temporary frame is built for the elevator machine room 1004, and the machine room together with a hoisting machine 1005 and a control panel is mounted in this frame and placed on the foundation floor of the elevator. At the same time, an overspeed governor is installed in the machine room and likewise a hoist 1017 serving as a lifting means, by means of which the future jump lifts are to be performed. The hoisting points for the hoisting rope 1018 or equivalent of the hoist are secured to the upper ends of the elevator guide rails by means of a special, easily releasable securing structure 1019 designed for this purpose. The hoist 1017 itself is well secured to the machine room and it is used to pull the machine room upwards in connection with a jump lift by means of the hoisting rope or equivalent supported by the upper ends of the elevator guide rails. If the working platform 1008 is an obstruction to movement of the securing structure 1019, it can be removed to a suitable place for the time it takes to perform the jump lift.

FIG. 7 illustrates a fourth stage of installation, wherein the machine room 1004 has been lifted to the level of the second floor and the elevator car 1003 is installed in the shaft on the foundation floor by building a car frame and securing the wall, ceiling and floor elements of the car to each other and to the car frame. At this stage, the electrification of the car can also be implemented. Moreover, the car is provided with a door and the finishing of the car is completed. At this stage the elevator is also provided with a hoisting rope, which is as yet coiled on a rope drum. In connection with the fourth stage, the elevator car 1003 is also connected to the machine room 1004 e.g. by means of chains 1006 to allow a jump lift.

In a fifth stage as illustrated by FIG. 8, the combination of machine room and elevator car is hoisted upwards through one floor-to-floor distance by means of the hoist 1017 and the combination is secured to the elevator guide rails 1002 already installed. At this stage also the currently topmost tie plate of the elevator guide rails is fixed firmly in place.

In a sixth stage of installation, the waterproof supporting platform 1007 is raised five floors upwards for a future jump lift and secured to the floor slab. The installation process is now continued by mounting in the next five-floor section the required piping and electrical equipment as well as the elevator guide rails 1002 and landing doors.

In a seventh stage as illustrated by FIG. 9, the actual jump lift is carried out. The elevator machine room 1004 together with the elevator car 1003 is pulled upwards through five floor-to-floor distances, the elevator car being thus lifted from the first floor level to the sixth floor level. The lifting is performed by means of the hoist 10017, the lifting force being received by the supporting points at the upper ends of the elevator guide rails 1002. Thus, the load resulting from the lifting is evenly distributed on the elevator guide rails 1002, so the lifting does not produce any stress on the building's own structures, such as walls, intermediate floor slabs or elevator shaft walls. After the jump lift has been carried out, the combination of machine room and elevator car is secured uniformly to the elevator guide rails 1002 already installed. In addition, the currently topmost tie plate of the elevator guide rails is again secured firmly in place.

FIG. 10 illustrates an eighth stage of elevator installation, wherein the required roping is installed. The hoisting ropes 1013 are passed from the traction sheave of the machine 1005 around the diverting pulley 1014 in the car frame. In addition, the overspeed governor rope 1012 is installed. The roping can also be done earlier, in which case the ropes are stretched in length when the jump lift is carried out. In addition, the required shaft components and switches are installed, whereupon the elevator is ready for inspection and operation within the six lowest floors.

In the next stage, the waterproof supporting platform 1007 is again raised five floors upwards for a future jump lift and secured to the floor slab. The installation process is now continued through the next five floors upwards in a manner corresponding to the above-described stages 6-8. The installation work is carried on by this method in jumps of five floors at a time, making the elevator ready for operation at levels higher and higher up in the building as the construction work progresses.

Some of the roping and rope pulleys have been omitted from FIGS. 7-10 for the sake of clarity.

It is obvious to the person skilled in the art that different embodiments of the invention are not limited to the example described above, but that they may be varied within the scope of the claims presented below.

In accordance with the examples described above, the skilled person may vary an embodiment of the invention e.g. by using a jump lift distance other than a five-floor distance as mentioned above. Depending on the circumstances, any distance equal to a floor height may be the most appropriate distance. Therefore, all floor-to-floor distances between 1 . . . 8 and suitably e.g. between 3 . . . 7 or between 4 . . . 6 may be mentioned.

It is also obvious to the skilled person that the order of different details of the installation method as well as the working method may vary. Likewise, the use and mode of operation of the hoist used for lifting the machine room may differ from the above description.

1. Method for installing an elevator without counterweight, in which elevator is a compensating system separating the roping portion of the hoisting ropes above the elevator car from the roping portion of the hoisting ropes below the elevator car and in which the rope tension is arranged by means of the compensating system to be greater in the portion of roping above the elevator car than in the portion of roping below the elevator car, in which method the travel height of the elevator is raised at least once, wherein when raising the travel height the extension of the hoisting ropes is fed in via the compensating system or via the rope fastening in the compensating system.

2. Method according to claim 1, wherein the hoisting means secured to the machine room during lifting of the machine room or similar, such as e.g. a console supporting the machine and at least one rope pulley, is connected by means of a hoisting rope or similar to a fastening structure supported on the upper end of the elevator guide rails.

3. Method according to claim 1, wherein the elevator car temporarily connected to the machine room is simultaneously raised the corresponding distance upwards during lifting of the machine room or similar.

4. Method according to claim 1, wherein the machine room or similar and the elevator car are in one step lifted a distance corresponding to 1 . . . 8 floor-to-floor distances, suitably 3 . . . 7 floor-to-floor distances and advantageously 5 floor-to-floor distances.

5. Method according to any claim 1 wherein the machine room and the elevator car are supported on the elevator guide rails after each raising of the machine room and the elevator car, after which the fastening structure of the hoisting means is detached from the upper end of the guide rails.

6. Elevator without counterweight, in which elevator is a compensating system separating the roping portion of the hoisting ropes above the elevator car from the roping portion of the hoisting ropes below the elevator car and in which the rope tension is arranged by means of the compensating system to be greater in the portion of roping above the elevator car than in the portion of roping below the elevator car, wherein the travel height of the elevator is raised at least once and in that feeding in of ropes to the hoisting ropes is arranged in the elevator via the compensating system or via the rope fastening in the compensating system.
